(19) United States
(12) Patent Application Publication
(10) Pub. No.: US 2022/0383159 A1
(43) Pub. Date: Dec. 1, 2022

(54) SYSTEMS AND METHODS FOR OPEN DOMAIN MULTI-HOP QUESTION ANSWERING

(71) Applicant: salesforce.com, inc., San Francisco, CA (US)

(72) Inventors: Semih Yavuz, Redwood City, CA (US); Kazuma Hashimoto, Menlo Park, CA (US); Yingbo Zhou, Palo Alto, CA (US)

(21) Appl. No.: 17/534,085

(22) Filed: Nov. 23, 2021

Related U.S. Application Data
(60) Provisional application No. 63/194,034, filed on May 27, 2021.

(51) Int. Cl. G06N 5/04; G06F 40/40; G06F 40/284

(52) U.S. Cl. CPC G06N 5/04; G06F 40/40; G06F 40/284

(57) ABSTRACT

Embodiments described herein provide a fusion-in-decoder (FID) based model (referred to as “PATHID”) for open-domain multi-hop question answering. Specifically, PATHID addresses the gap between the general behavior of the FID model on single-hop and multi-hop question answering, and provides more transparency into the reasoning path. In addition to answer generation, PATHID explicitly models the full reasoning path to resolve the answer with a generative sequence-to-sequence model.

### CROSS-REFERENCE

The instant application is a nonprovisional of and claims priority under 35 U.S.C. § 119 to commonly-owned and U.S. provisional application no. 63/194,034, filed May 27, 2021, which is hereby expressly incorporated by reference herein in its entirety.

### TECHNICAL FIELD

The embodiments relate generally to machine learning systems and natural language processing, and more specifically to generative models for open domain multi-hop question answering.

### BACKGROUND

Open-domain question answering aims at finding a factoid answer for a given question using a large collection of document corpus such as Wikipedia. In other words, open-domain question answering models often need to distill knowledge from document corpus. Some complex questions may require the question-answering model to combine multiple pieces of evidence from multiple documents. For example, the question “what time frame did the football manager who recruited David Beckham manage Manchester United?” contains multiple hops of sub-questions such as which football manager recruited David Beckham, when the football manager managed Manchester United, and/or the like. Such complex questions are referred to as multi-hop questions, and often require leveraging knowledge to make complex reasoning.

Some existing systems have achieved super-human level performance on standard benchmarks like SQuAD for single-passage question answering. However, the performance of open-domain question answering is still largely subpar, especially for multi-hop questions requiring more complex reasoning.

Therefore, there is a need for improved open-domain question answering systems.

### BRIEF DESCRIPTION OF THE DRAWINGS

FIG. 1 is a simplified diagram 100 illustrating an example of the multi-hop question answering framework for multi-hop question answering, according to one embodiment described herein.

FIG. 2 is a diagram illustrating an example of the question-passage block preprocessing, according to one embodiment described herein.

FIG. 3 is a diagram illustrating an example of the question-passage block preprocessing, according to one embodiment described herein.

FIG. 4 is a simplified diagram of a computing device for a multi-hop question answering system, according to some embodiments described herein.

FIG. 5 is a simplified logic flow diagram of a method 500 for multi-hop question answering and reasoning using the multi-hop question answering framework at inference stage described in FIG. 1, according to some embodiments described herein.

FIG. 6 is a simplified logic flow diagram of a method 600 for multi-hop question answering and reasoning using the multi-hop question answering framework at training stage described in FIG. 1, according to some embodiments described herein.

FIGS. 7-11 provide example data charts illustrating performance of data experiments for the multi-hop question answering framework, according to some embodiments described herein.

FIGS. 12-13 provide example model parameters for the multi-hop question answering framework, according to some embodiments described herein.

In the figures, elements having the same designations have the same or similar functions.

### DETAILED DESCRIPTION

Recent development in question and answering systems has shown a generative approach at combining evidence from multiple passages for answer generation. For example, based on large pre-trained transformers such as T5 (Raffel et al., Exploring the limits of transfer learning with a unified text-to-text transformer. Journal of Machine Learning Research, 2020), a fusion in-decoder (FID) model that leverages passage retrieval with generative models has been developed for open-domain question answering. The FID model achieves success across several single-hop question-answering benchmarks. However, the success of FID models barely extends to multi-hop question-answering. In addition, the FID model is a rather opaque model in terms of interpretation of the answer generation process. For multi-hop question-answering which requires sequential reasoning across multiple evidence from the pool of retrieved passages, there is a need to provide reasoning of an answer path.

In view of the need for a more transparent answer and reasoning path for multi-hop question answering, embodiments described herein provide an FID-based generative model (referred to as “PATHID”) for open-domain multi-hop question answering. Specifically, PATHID model is configured to generate an answer along with a reasoning path to improve its capability of multi-hop reasoning. In addition to answer generation, PATHID explicitly models the full reasoning path to resolve the answer with a generative sequence-to-sequence model.

Specifically, the PATHID model formulates a multi-hop question and answering problem as a single sequence prediction task that simultaneously models question type, reasoning path consisting of supporting passages and facts, and eventually the factoid answer. Furthermore, the PATHID model allows for higher order interaction between the retrieved passages to obtain more expressive representations from the encoder to facilitate modeling a complex reasoning chain as a single sequence by the decoder.

In this way, the PATHID model extends multi-hop question answering beyond just answer generation by explicitly modeling the full reasoning path to resolve the answer with a generative sequence-to-sequence model.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

### Overview

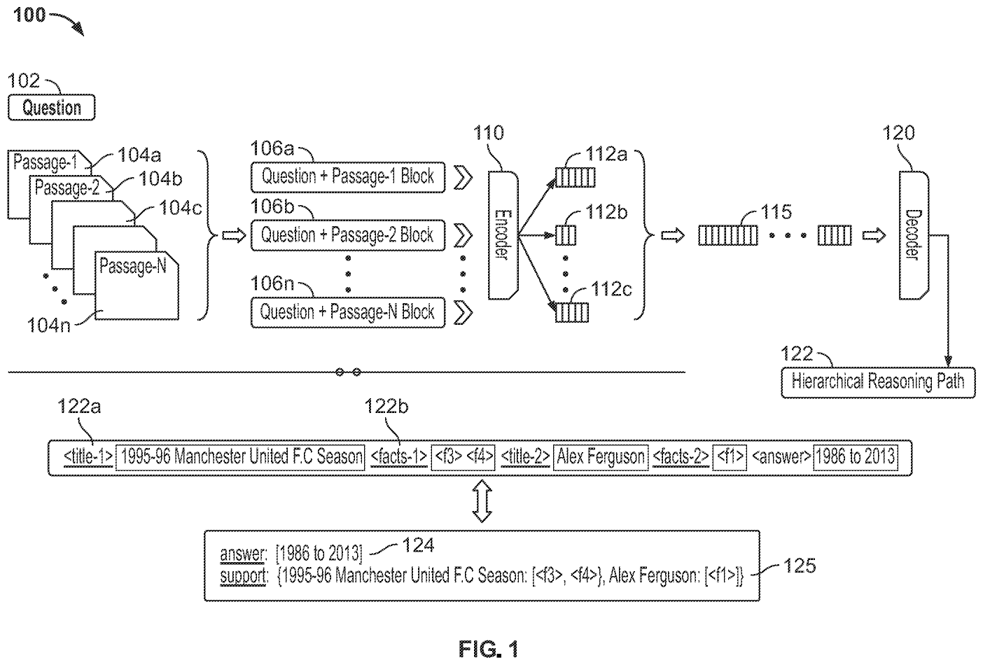

FIG. 1 is a simplified diagram 100 illustrating an example of the PATHID framework for multi-hop question answering, according to one embodiment described herein. The PATHFID framework may include an encoder 110 and a decoder 120, which may be built based on a sequence-to-sequence architecture initialized from pre-trained models such as T5 or BART as described in Lewis et al., BART: Denoising sequence-to-sequence pre-training for natural language generation, translation, and comprehension, in Proceedings of the 58th Annual Meeting of the Association for Computational Linguistics, 2020.

A multi-hop question-answering system, such as the PATHFID model, may receive a collection of K passages 104a-n for a multi-hop question 102 q: D_{q}={p₁,p₂, . . . ,pₖ}. The passage set D_{q} of passages 104a-n can be a pre-defined set, or it can also be an output from a text retrieval system that retrieves relevant passages for an input question (e.g., DPR described in Karpukhin et al., Dense passage retrieval for open-domain question answering. In Proceedings of the 2020 Conference on Empirical Methods in Natural Language Processing (EMNLP), 2020 and MDR described in Xiong et al., Answering complex open-domain questions with multi-hop dense retrieval, in proceedings of International Conference on Learning Representations, 2021) in an open-domain question-answering setting. For example, D_{q} may be a subset of a large collection of passages, such as Wikipedia. The task for the PATHID model is to generate an answer string a given q and D_{q}. In addition, the PATHID model is configured to identify which passages provide evidence, and which sentences in them are describing the evidence as the reasoning of the final answer to the question 102.

In one embodiment, the question 102 is combined with each passage block 104a-n to form a question-passage block 106a-n, respectively. Specifically, each passage 104a-n contains a title tₙ and a context tₙ. Then, the PATHID model constructs a single block bₙ:=question: q title: tₙ context: pₙ of concatenated evidence from each passage-title pair (pₙ,tₙ) together with the question 102 (q). In particular, the PATHFID model employs a single sequence-to-sequence architecture that independently encodes the input passages after inserting special fact markers (<fᵢ>) before the i-th sentence of each passage. For example, each input passage-title pair (pₙ, tₙ) is independently encoded along with the question q as a separate block

bₙ^{path}:=question:q title:tₙ context:pₙ^{path}

where the context representation is defined by inserting special tokens (<fᵢ>) before each sentence of the passage as

pₙ^{path:=<f}₁>sₙ⁽¹⁾<f₂>sₙ⁽²⁾ . . . <fₗ_{_{n>s}}ₙ^{(l}^{ₙ}⁾

where sₙ⁽ⁱ⁾ denotes the i-th sentence of passage pₙ, and lₙ is the number sentences it contains.

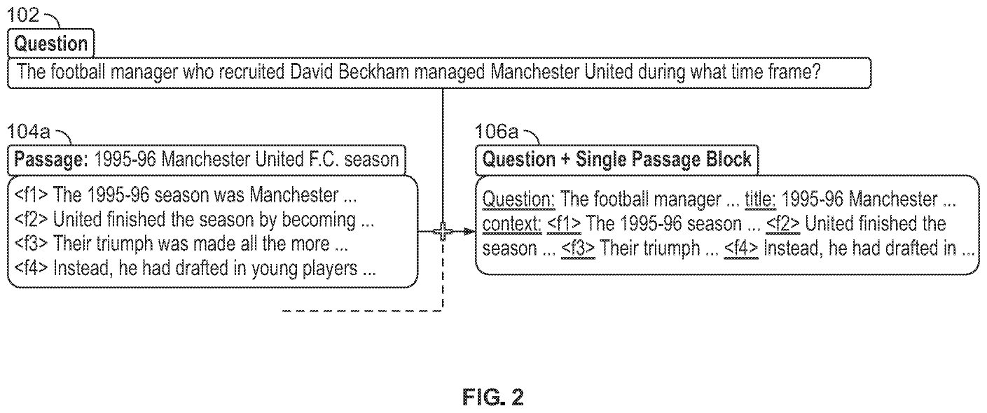

For example, FIG. 2 is a diagram illustrating an example of the question-passage block preprocessing, according to one embodiment described herein. The example multi-hop question answering sample is taken from the HotpotQA dataset. It requires fusing multiple evidence (supporting facts) from multiple passages in a certain order to arrive at the correct answer.

For the example passage 104a entitled “1995-1996 Manchester United F.C. season,” each sentence is prepended with a fact marker <fᵢ>. Thus, for the input question 102 “The football manager who recruited David Beckham managed Manchester United during what time frame,” an example question-passage block 106a concatenates the question 102 with the passage 104a, with each sentence from the passage 104a being separated with the fact markers <f₁ >, <f₂ >, . . . Each fact marker signifies a piece of evidence in the passage.

Referring back to FIG. 1, the generated question-passage blocks 106a-n may then be input to the encoder 110. The encoder 110 may then encode each of the resulting evidence block bₙ^{path}(106a-n) independently into |bₙ^{path}|×d-dimensional output representations 112a-n, respectively. The encoded representations 112a-n are then concatenated to form a unified input representation 115, denoted by:

X_{q}^{path}=[Enc(b₁^{path});Enc(b₂^{path}); . . . ;Enc(b_{N}^{path})]

Note that sentence indicators (<fᵢ>) are shared across all passages, encouraging a more hierarchical passage representation by explicitly breaking them down into sentence-level sub-blocks using the same indicator tokens.

The concatenated global (unified) input 115 is then set to the decoder 120. Conditioning on the concatenation of token-level input representations per passage, the decoder 120 then generates a linearized hierarchical reasoning path 122 obtained by concatenating the sequence of passage titles and their corresponding supporting fact pointers followed by the answer. Each segment on the reasoning path is separated by special markers in a way that makes it possible to uniquely recover the individual segment predictions after decoding in the inference time.

More precisely, if a question q requires K-hop reasoning, then the K passages are processed in a sequential order alternating between their passage-level and sentence-level evidence until the answer is reached. To this end, let R_{q}={pᵣ_{₁},pᵣ_{₂}, . . . ,pᵣ_{_{K}}} with rᵢ∈[1, N] denote the subset of sequence of passages from the larger pool D_{q} reflecting this reasoning process for locating the answer a for question q. The hierarchical reasoning path 122 which takes a form as a linearized sequence of alternating blocks of passage titles (e.g.,122a, 122c), and supporting facts (e.g., 122b, 122d) followed by the answer block is given by:

Y_{q}^{path}:=[Tᵣ_{₁}; Eᵣ_{₁}; Tᵣ_{₂}; . . . ; T_{K}; Eᵣ_{_{K}}; A]

where Tᵣ_{ᵢ} represents the i-th title block obtained by inserting a special token (<title-i>) before the title tᵣ_{ⱼ} and A denotes the answer block derived by prepending a special token (<answer>) to the answer a. On the other hand, i-th supporting fact block is defined as the sequence of fact indicators following <facts-i > token by

Eᵣ_{ᵢ}:= [symbol] facts-i [symbol] <fⱼ_{₁}><fⱼ₂> . . . <fⱼ_{ₘ₁}>

where {j₁,j₂, . . . ,jₘ _{ᵢ}} denote the indices of key sentences to leverage from passage pᵣ_{ᵢ} to transition to the next evidence on the reasoning process R_{q} for question q, and 1≤mᵢ ≤lᵣ_{ᵢ} denotes the number of supporting facts. Note that fact indicators <fᵢ> are shared between the contexts pₙ^{path} of input blocks and supporting fact blocks on the target reasoning path to allow the decoder to follow along the sequential reasoning R_{q} by pointing to the facts Eᵣ_{ᵢ} of passage Pᵣ_{ᵢ}.

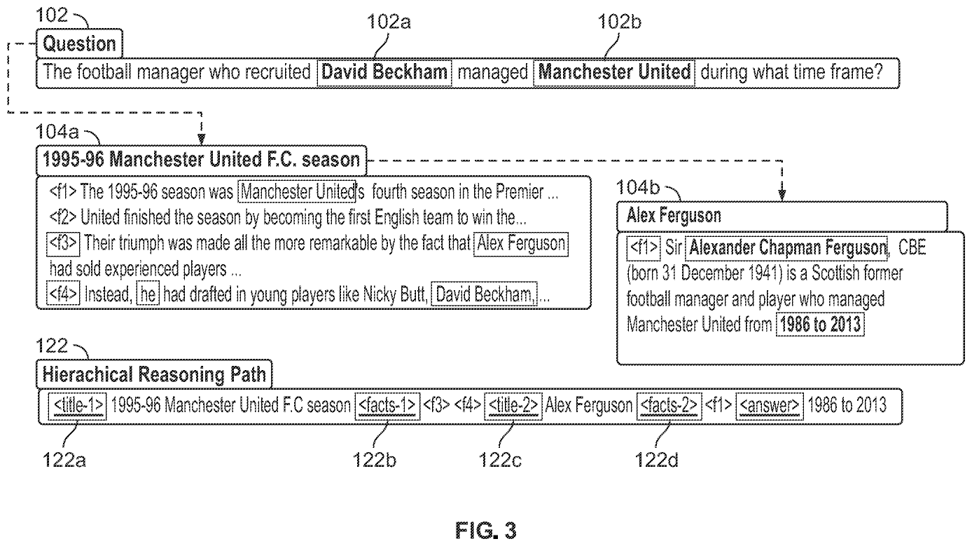

For example, FIG. 3 is a diagram illustrating an example of the question-passage block preprocessing, according to one embodiment described herein. As shown in FIG. 3, some sentences in the two paragraphs 104a and 104b are crucial to answer the question 102. Moreover, there is a reasoning flow: the question 102→the first paragraph in passage 104a→the second paragraph in passage 104b, which is called a reasoning path. The overall task is then to predict the reasoning path along with the supporting facts, and the answer.

The input question 102 requires fusing multiple evidence (supporting facts) relating to “David Beckham” 102a and “Manchester United” 102b in the question 102 from multiple passages in a certain order to arrive at the correct answer. For instance, the sentences <f₃> and <f₄> in passage 104a provides the supporting fact “Alex Ferguson” is the person who drafted “David Beckham.” Then another passage titled “Alex Ferguson” 104b may be followed by the decoder, in which the sentence <f₁> provides the supporting fact that “Alex Chapman Ferguson” managed Manchester United from “1986 to 2013.” This process is formulated as a single sequence prediction of the linearized hierarchical path 122 ending with the answer, as described above in relation to FIG. 2.

In one embodiment, the title of the passage may be reconstructed from the reasoning path by token including the separator tokens. However, the decoder 120 might fall into some minor errors during the generation process, which may cause the resulting titles to end up slightly different from the original ones. To account for such minor errors, a set of titles coming from the input passages 104a-n may be leveraged and the most similar among them may be identified to be the generated passage titles based on token-level F1-score.

Referring back to FIG. 2, the predicted linearized hierarchical path 122 contains alternating blocks of passage titles (e.g.,122a, 122c), and supporting facts (e.g., 122b, 122d ), separated by title or fact markers. The answer 124 may be parsed from the predicted linearized hierarchical path 122 following the answer marker. A reasoning path 125 can be parsed from the predicted linearized hierarchical path 122 based on the fact markers indicating the sentences from passages providing evidence in forming the final answer.

In one embodiment, the PATHFID model may incorporate evidence fusion through the reasoning path to guide the model to towards correct answer in a structured way. However, it still relies on the decoder to combine all the clues together, which might still struggle due to lack of cross-passage interactions as input blocks are encoded independently. To improve the model performance, cross-passage interaction may be captured by redefining the input block consisting of a pair of passages (pₙ_{₁},pₙ_{₂}) as

bₙ_{_{1,}}ₙ_{₂}^{path+}:=question:q<title-1>tₙ_{₁}<context-1>pₙ_{₁}^{path}<title-2>tₙ_{₂}<context-2>pₙ^{path}

For example, the set of passage pairs (pₙ_{₁}), (pₙ_{₂}) are available for the PATHFID model to consume. In particular, a set of pairs of passages are derived from the initial set D_{q} by D_{q}^{+={(p*, p}₁),(p*,p₂), . . . , (p*, p_{N})} where p* corresponds to the first passage that is possible to immediately hop to from question q, which may be determined by another model, or by executing the original PATHFID on D_{q}. The global input representation 115 X_{q}^{patht} may then be obtained similarly by encoding the new blocks bₙ_{_{1,}}ₙ_{₂} ^{path+} allowing for cross-passage interactions, while the target reasoning path Y_{q}^{path+} may be generated by the decoder in a similar manner as Y_{q}^{path} . Note that special markers are shared between new input block bₙ_{₁}_{,n}_{₂}^{path} and target reasoning path Y_{q}^{path+} to provide the model with additional clue regarding the first passage on the reasoning path while still relaying the complete evidence fusion to the decoder via information redundancy encoded in X_{q}^{path+.}

### Computer Environment

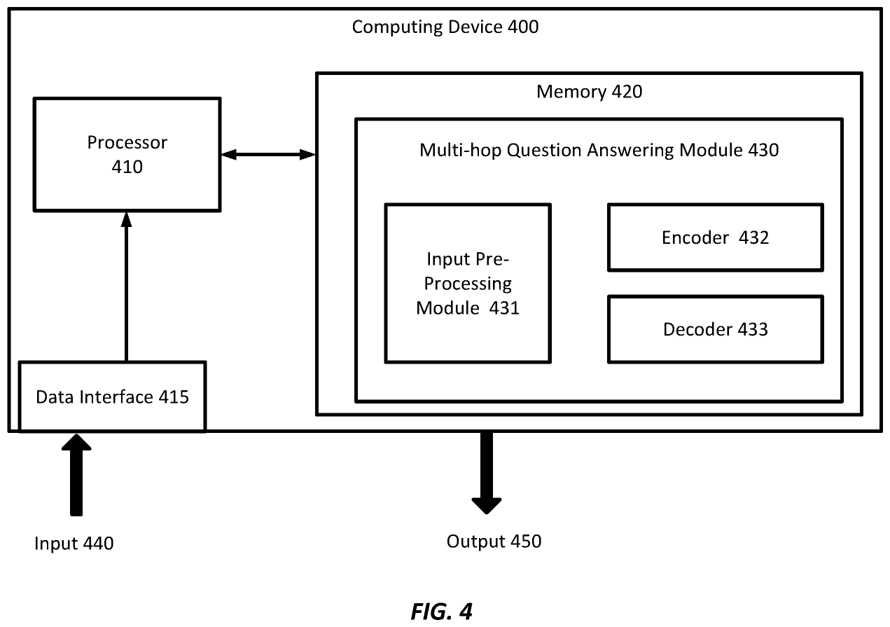

FIG. 4 is a simplified diagram of a computing device for a multi-hop question answering system, according to some embodiments described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for an open-domain multi-hop question answering module 430 that may be used to implement and/or emulate the systems and models, and/or to implement any of the methods described further herein. In some examples, the open-domain multi-hop question answering module 430, may receive an input 440, e.g., such as a question, via a data interface 415. The data interface 415 may be any of a user interface that receives a user utterance of a question, or a communication interface that may receive or retrieve a previously stored question from multi-hop question and answering training data from the database. The field extraction module 430 may generate an output 450, such as a system response to the input 440.

In some embodiments, the open-domain multi-hop question answering module 430 may further includes the input pre-processing module 431, an encoder 432 and a decoder 433. The input pre-processing module 431 may be configured to process the input question 102 and passages 104a-n, by concatenating the question and the passage blocks into question-passage blocks 106a-n, as described in relation to FIG. 1. The encoder 432 may be similar to the encoder 110 in FIG. 1, and the decoder 433 may be similar to the decoder 120 in FIG. 1. Examples of the encoder 432 and decoder 433 may be discussed below with respect to the data experiments implementations.

The multi-hope question answering module 430 and the submodules 431-433 may be implemented using hardware, software, and/or the combination thereof.

### PATHFID Workflows

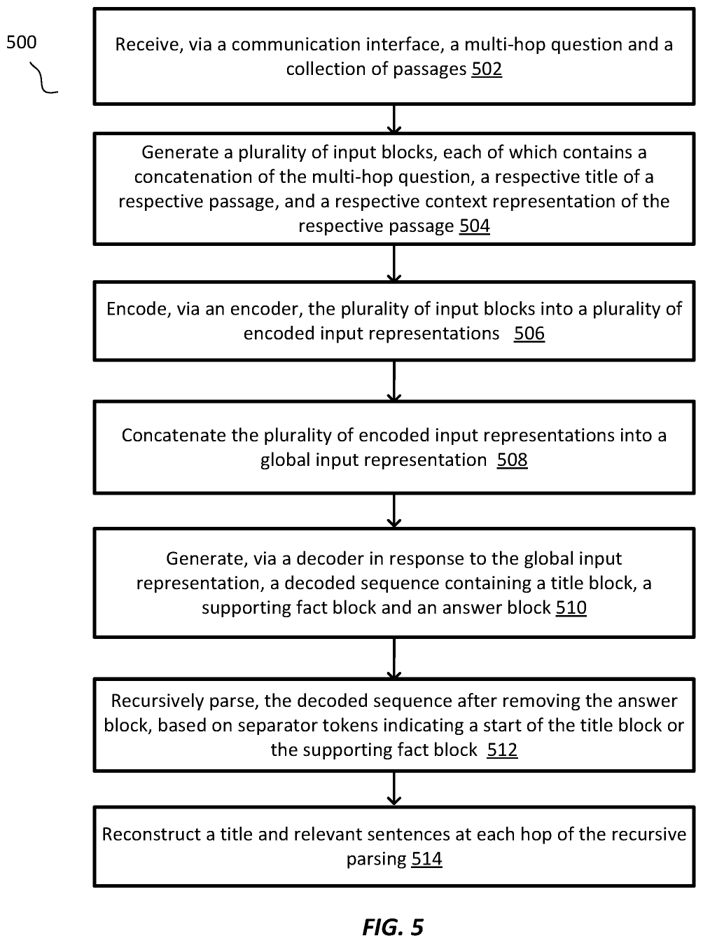

FIG. 5 is a simplified logic flow diagram of a method 500 for multi-hop question answering and reasoning using the PATHID framework at inference stage described in FIG. 1, according to some embodiments. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of multi-hop question answering module 430 (FIG. 4) to perform the task of generating the causal knowledge graph for root cause analysis. As illustrated, the method 500 includes a number of enumerated steps, but aspects of the method 500 may include additional steps before, after, and in between the enumerated steps. In some respects, one or more of the enumerated steps may be omitted or performed in a different order.

At step 502, a multi-hop question (e.g., question 102 in FIG. 1) and a collection of passages (e.g., passages 102a-n in FIG. 1) may be received receiving, via a communication interface (e.g., 415 in FIG. 4).

At step 504, a plurality of input blocks (e.g., question-passage blocks 106a-n in FIG. 1) may be generated. Each input block contains a concatenation of the multi-hop question (e.g., question 102 in FIG. 1), a respective title of a respective passage, and a respective context representation of the respective passage. For example, the context representation is generated by inserting special fact tokens <fᵢ> that signify starts of a sentence before each sentence of the respective passage.

In one implementation, an input block from the plurality of input blocks may contain cross-passage information, e.g., a concatenation of the multi-hop question, a first title of a first passage, a first context representation of the first passage, a second title of a second passage, and a second context representation of the second passage.

At step 506, an encoder (e.g., 110 in FIG. 1) may encode the plurality of input blocks into a plurality of encoded input representations (e.g., 112a-n in FIG. 1).

At step 508, the plurality of encoded input representations into a global input representation (e.g., 115 in FIG. 1).

At step 510, the decoder (e.g., 120 in FIG. 1) may generate, in response to the global input representation, a decoded sequence (e.g., the hierarchical reasoning path 122 in FIG. 1) containing a title block (e.g., 122a in FIG. 1), a supporting fact block (e.g., 122b in FIG. 1) and an answer block. For example, the decoder consumes the input representation X_{q}^{path} computed by encoder and generates the full reasoning path token by token. The decoder may generate the decoded sequence in a form of a conditional probability distribution of the decoded sequence conditioned on the global input representation autoregressively per token at each step via a self-attention module, a cross-attention module and a feed-forward module.

Specifically, the decoded sequence contains a linearized sequence of alternating title blocks and supporting fact blocks, and the alternating title blocks and supporting fact blocks are selected from a sequence of passages indicating a reasoning for locating the answer to the multi-hop question from the collection of passages, as described in relation to FIG. 3. The supporting fact block contains a fact starting token followed by a sequence of fact indicators <facts-i> corresponding to special fact tokens in the context representation.

At step 512, the decoded sequence (e.g., the hierarchical reasoning path 122 in FIG. 1) may be recursively parsed after removing the answer block, based on separator tokens indicating a start of the title block or the supporting fact block.

At step 514, a title and relevant sentences may be reconstructed at each hop of the recursive parsing to form the reasoning path (e.g., 125 in FIG. 1) of the final answer (e.g., 124 in FIG. 1). For example, the decoded sequence is processed using the answer indicator (<answer >) to first obtain the answer, followed by recursively parsing the remaining sequence using the special separator tokens (<title-k >, <facts-k >) to reconstruct the title and retrieve its relevant sentences at each hop k. As illustrated in FIG. 3, the final result of the inference can be summarized into a dictionary which maps each generated passage title to the list of sentence pointers as well as the final answer.

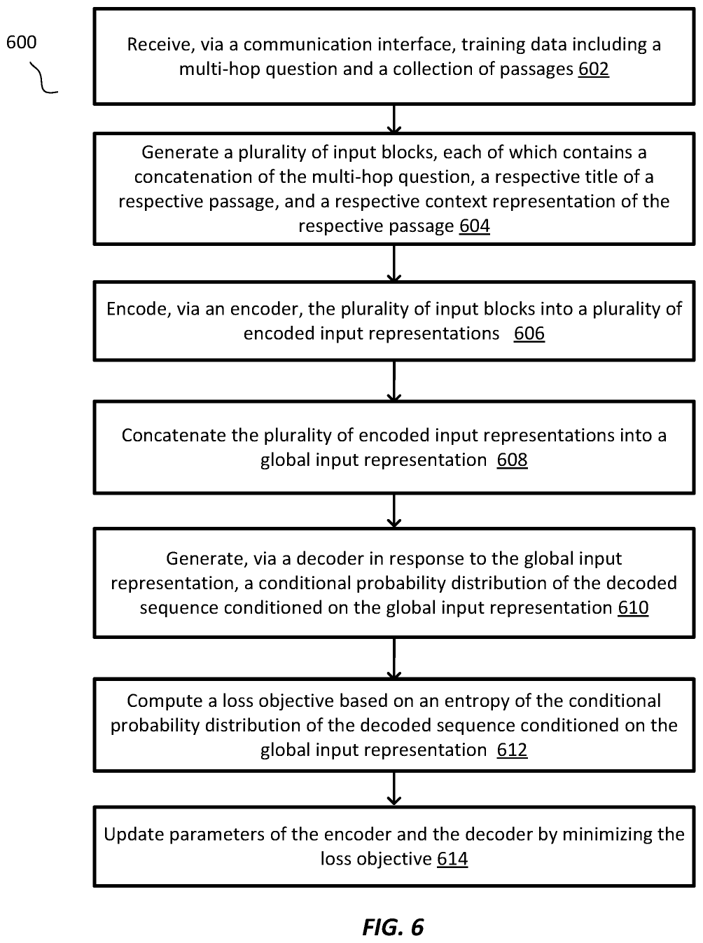

FIG. 6 is a simplified logic flow diagram of a method 600 for multi-hop question answering and reasoning using the PATHID framework at training stage described in FIG. 1, according to some embodiments. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of multi-hop question answering module 430 (FIG. 4) to perform the task of generating the causal knowledge graph for root cause analysis. As illustrated, the method 600 includes a number of enumerated steps, but aspects of the method 500 may include additional steps before, after, and in between the enumerated steps. In some respects, one or more of the enumerated steps may be omitted or performed in a different order.

At step 602, training data including a multi-hop question (e.g., question 102 in FIG. 1) and a collection of passages (e.g., passages 102a-n in FIG. 1) may be received receiving, via a communication interface (e.g., 415 in FIG. 4).

At step 604, a plurality of input blocks (e.g., question-passage blocks 106a-n in FIG. 1) may be generated. Each input block contains a concatenation of the multi-hop question (e.g., question 102 in FIG. 1), a respective title of a respective passage, and a respective context representation of the respective passage. For example, the context representation is generated by inserting special fact tokens <fᵢ> that signify starts of a sentence before each sentence of the respective passage.

At step 604, a plurality of input blocks (e.g., question-passage blocks 106a-n in FIG. 1) may be generated. Each input block contains a concatenation of the multi-hop question (e.g., question 102 in FIG. 1), a respective title of a respective passage, and a respective context representation of the respective passage. For example, the context representation is generated by inserting special fact tokens <fᵢ> that signify starts of a sentence before each sentence of the respective passage.

At step 606, an encoder (e.g., 110 in FIG. 1) may encode the plurality of input blocks into a plurality of encoded input representations (e.g., 112a-n in FIG. 1).

At step 608, the plurality of encoded input representations into a global input representation (e.g., 115 in FIG. 1).

At step 610, the decoder (e.g., 120 in FIG. 1) may generate, in response to the global input representation, a decoded sequence (e.g., the hierarchical reasoning path 122 in FIG. 1) containing a title block (e.g., 122a in FIG. 1), a supporting fact block (e.g., 122b in FIG. 1) and an answer block. For example, the decoder may generate the decoded sequence in a form of a conditional probability distribution of the decoded sequence conditioned on the global input representation.

At step 612, a loss objective may be computed based on an entropy of the conditional probability distribution of the decoded sequence conditioned on the global input representation. For example, upon receiving the global input representation X_{q}^{path}, the decoder autoregressively generates the reasoning path Y_{q}^{path} per token at each step by following self-attention, cross-attention on the entire X_{q}^{path}, and feed-forward modules. So, the overall reasoning path generation is modeled as conditional generation p_{θ}_{^{path}}(Y_{q}^{path}|X_{q}^{path}) The model then is trained to minimize

J(θ^{path})=−Σᵢ₌₁^{|Y}^{_{q}}^{^{path}}^{|}log p_{θ}(yᵢ|y_{<i,}X_{q}^{path})

with teacher forcing over a training set of {(q, a, D_{q})}.

At step 614, the parameters of the encoder and the decoder may be updated by minimizing the loss objective.

### Example Implementation and Performance

The HotpotQA dataset (described in Yang et al., HotpotQA: A dataset for diverse, explainable multi-hop question answering. In Proceedings of the 2018 Conference on Empirical Methods in Natural Language Processing, 2018) is a large-scale human-annotated dataset including 113 k multi-hop questions. It focuses on using documents from Wikipedia as the source of information for answering questions rather than knowledge bases as in other multi-hop QA datasets. The questions in HotpotQA are not restricted by the fixed KB 168 schema and hence they can cover more diverse topics. The answer for each question in HotpotQA is extracted from 10 paragraphs in the distractor setting, while it is allowed to use the entire Wikipedia for the full wiki setting. There are two main question types bridge (20%) and comparison (80%) in the corpus. While both types require reasoning over two passages, bridge questions often require identifying the bridge entity in the first passage to correctly hop to the second one, which contains the answer. Each question is also provided with the annotation of 2 supporting passages and up to 5 corresponding relevant sentences as their supporting facts. Here, the data experiments primarily adopt the distractor setting as PATHFID is reader model that reasons over a given set of evidence documents. However, the results of PATHFID for open-domain setting are also reported as a case study.

Standard metrics exact-match (EM) and F1 scores are used for measuring the quality of predicted answers. Unlike the original FID model, PATHFID is evaluated on supporting fact predictions using the official metrics (Support-EM, Support-F1), which measures the performance of the reader model in correctly identifying the supporting facts from the relevant passages. Note that this metric implicitly requires correctly identifying relevant passages as well.

A pre-trained T5-large encoder-decoder to initialize the models in the data experiments. The encoder-decoder model is then trained with batch size of 64 with constant learning rate of 1e-4 for 10 epochs of training for the experiments in the distractor setting, due to computational cost and relatively little gain, the iteration size is reduced to 10K steps (6.5 epochs) for the open-domain setting. A maximum length of 256 (resp. 512) tokens for input blocks of PATHFID (resp. PATHFID+), while the maximum target sequence length is set to be 64. 189 However, the sequence truncation is performed on the reasoning path excluding answer part for sequences of length longer than 64 tokens. All the experiments are conducted on a machine with 4 or 8 many 40 GB A100 GPUs.

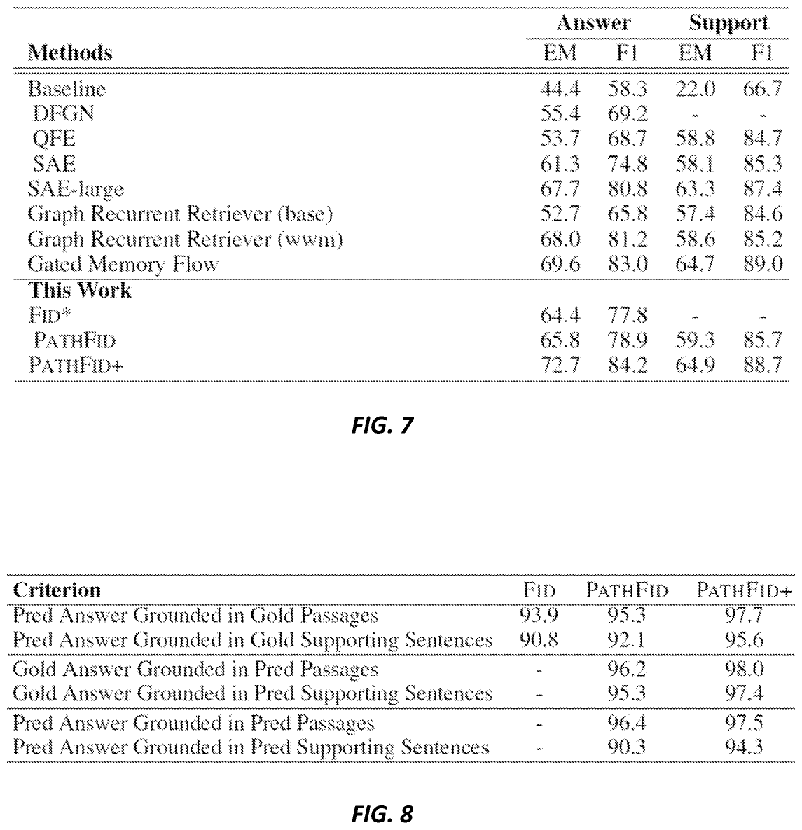

FIG. 7 shows the data experiment results of the PATHFID model on the HotpotQA distractor setting. PATHFID reader provides 1.4% absolute gain on answer EM score in comparison to FID model. Moreover, it achieves competitive supporting fact predictions of 59.3% support-EM and 85.7% support-F1 as a result of path generation compared to strong extractive models such as Asai et al., Learning to retrieve reasoning paths over wikipedia graph for question answering. In International Conference on Learning Representations, 2020. In summary, PATHFID establishes the usefulness of modeling the full reasoning path along with answer generation for multi-hop question answering. More notably, PATHFID+ achieves a quite significant performance gain across all the central evaluation metrics, demonstrating the importance of cross-passage interactions. Overall results validate the effectiveness of the two central modeling contributions of our proposed method. Further analysis and discussion are provided below on the unique advantages of PATHFID approach under a few central questions.

For example, one question remains to be answered would be how faithfully grounded are the generated answers on supporting facts. In FIG. 8, a detailed analysis is presented comparing different models in terms of the faithfulness of their generated answers on both gold and predicted supporting facts. The first row focuses on the passage-level answer grounding computed by the percentage of the answers found in one of the gold supporting passages, while the second row reports the same analysis on sentence-level. It is observed that PATHFID models significantly improves on how faithfully the generated answers are grounded on the supporting facts both at passage-level and sentence-level granularities. The next two rows provide further insight into the quality of the generated supporting facts by PATHFID models by measuring how often the gold answer can be found in them. This analysis shows that the generated supporting facts are of quite high-quality including the gold answer for more than 95.3% and 96.2% at sentence-level and passage-level, respectively. The last two rows measure the faithfulness of the generated answers on the model generated supporting facts, which is not applicable to FID model as it does not perform supporting fact prediction.

It is further observed that the generated answers are quite faithfully grounded on the predicted supporting facts, showing the path generation not only improves the answer EM performance but also successfully grounds them on the evidence it generates as part of the full reasoning path. It is important clarify that the extractive reader models can be guaranteed to output perfectly grounded answers simply by locating the answer in their predicted supporting facts. On the other hand, it is difficult for generative models to ensure 100% answer grounding simply due to its generative nature. However, additional evidence is provided validating the answers generated by PATHFID are significantly grounded in the supporting facts it generates, which might implicitly indicate that the generated reasoning path tightly aligns with the model's underlying process for answer generation.

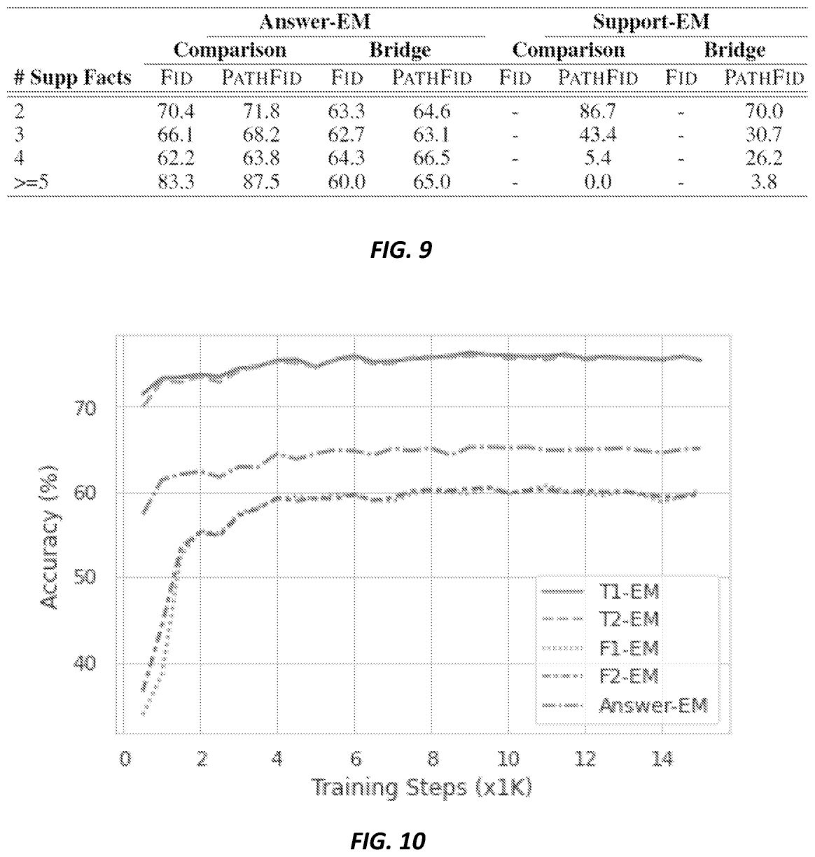

Performance breakdown is further provided by the number of supporting facts and question types. In FIG. 9, the performance of models is compared by breaking them down based on the number of gold supporting sentences and the question type (e.g., bridge and comparison). The first observation is that PATHFID 234 provides consistent improvement on answer-EM score over FID across both the question types and different number of supporting facts required to answer the question. Surprisingly, both models perform considerably well on the comparison questions even when it requires at least 5 supporting facts. A more important reason behind the performance breakdown analysis was to understand how the supporting fact prediction of PATHFID would change as the number of gold supporting facts grows. Although it starts degrading on examples with more than 2 supporting facts, it still achieves more than 25% Support-EM for bridge questions with up to 4 supporting facts. Recalling the average performance on the whole dataset is less than 60%, this result might be satisfactory enough performance, especially for a fully generative model on a very strict evaluation metric.

Next, the evolution of sub-tasks is analyzed during joint training with PATHFID. In FIG. 10, the evolution of PATHFID model is presented on the HotpotQA development set at every 500 training steps. While the model more quickly picks up the patterns for title generation, it takes much longer for it to reach to a reasonable level of fact prediction. As one would expect, the general trend in the evolution of different segments (title-1, facts-1, title-2, facts-2, answer) of the reasoning path mostly follows the difficulty of the corresponding sub-task although all the sub-tasks are jointly formulated and trained in an end-to-end fashion. On the other hand, it seems counter-intuitive for model to reach to a better accuracy on predicting the facts of the second passage (F2-EM) on the reasoning path earlier despite having a better accuracy on (T1-EM). However, one can also interpret it as a result of stronger feedback provided by the answer segment of the reasoning path as most of the ground-truth answers are contained in the facts of the second passage.

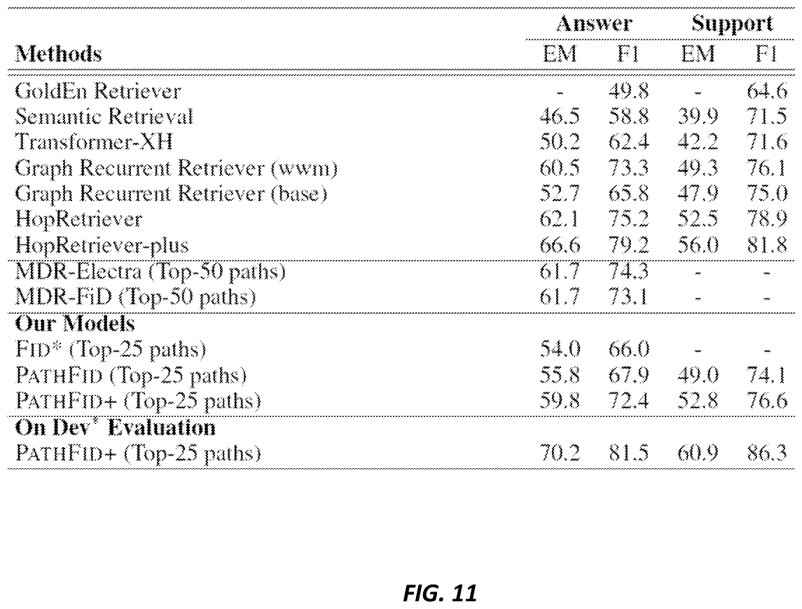

FIG. 11 provides the evaluation results of PATHFID in open domain setting of HotpotQA leveraging a recently proposed multi-hop dense retriever (MDR) for passage retrieval. Unlike distractor setting, MDR returns a set of passage pairs:

D_{q}^{MDR}={(p₁⁽¹⁾,p₁⁽²⁾), (p₂⁽¹⁾,p₂⁽²⁾), . . . (p_{N}⁽¹⁾,p_{N}⁽²⁾)}

for question q, where each passage pₙ⁽ⁱ⁾ comes with a title tₙ⁽ⁱ⁾ being retrieved from Wikipedia corpus. This setting naturally fits into how we formulate PATHFID+, which operates on the pairs of input passages set by D_{q}^{+=D}_{q} ^{MDR}.For experiments with FID and PATHFID, which operate on set of single input passages, we simply split the pairs into single passages, ending up with 2K passages when using top-K retrieved paths from MDR. Similar to the observation in distractor setting, PATHFID provides a significant (% 1.8) answer EM score improvement over FID, while also achieving a quite competitive performance on the supporting fact prediction compared to strong discriminative models (Asai et al., 2020, Li et al., Hopretriever: Retrieve hops over wikipedia to answer complex questions, CoRR, abs/2012.15534, 2020. URL https://arxiv.org/abs/2012.15534, 2020) optimized for better retrieval performance. Most notably, PATHFID+provides significant gains over PATHFID, achieving 59.8% answer-EM and 52.8% supporting fact EM score, showing the importance of encoding cross-passage interactions. Finally, the same PATHFID+ model is also evaluated on Dev* obtained by adding the pair of gold passages in D_{q}^{MDR} where the error propagation is isolated from the underlying retriever. FIG. 11 shows that both the answer and supporting fact prediction performance improves quite significantly, showing the potential impact that developments on retriever side of the problem can also make.

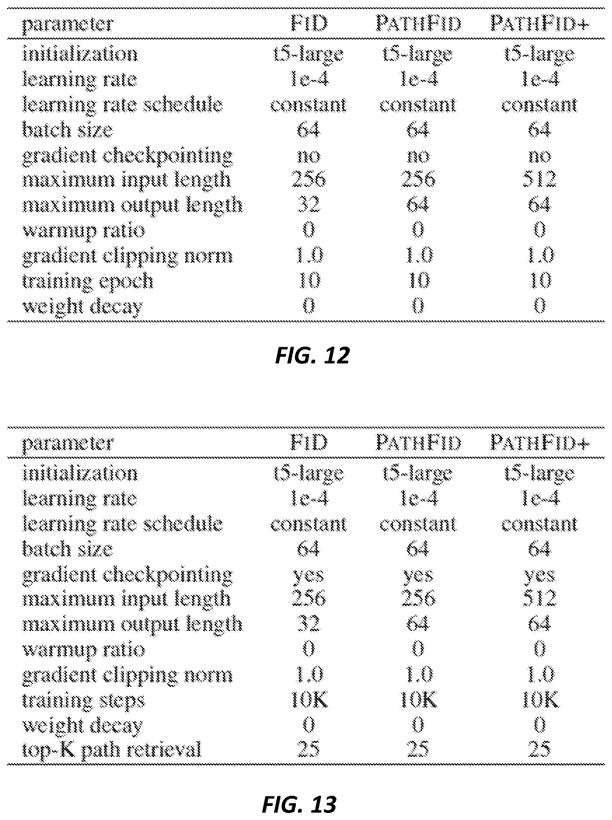

FIGS. 12-13 provide example hyperparameters used for the PATHID model. For example, FIG. 12 provides example hyper-parameters used in the distractor setting, and FIG. 13 provides example hyper-parameters used in the full-wiki settings, respectively.

Some examples of computing devices, such as computing device 400 may include non-transitory, tangible, machine readable media that include executable code that when run by one or more processors (e.g., processor 110) may cause the one or more processors to perform the processes of method 400. Some common forms of machine-readable media that may include the processes of method 400 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method for multi-hop question answering and reasoning via a natural language processing (NLP) model, the method comprising:
receiving, via a communication interface, a multi-hop question and a collection of passages;
generating a plurality of input blocks, each of which contains a concatenation of the multi-hop question, a respective title of a respective passage, and a respective context representation of the respective passage;
encoding, via an encoder, the plurality of input blocks into a plurality of encoded input representations;
concatenating the plurality of encoded input representations into a global input representation;
generating, via a decoder in response to the global input representation, a decoded sequence containing a title block, a supporting fact block and an answer block; and
generating an answer to the multi-hop question based on the answer block and a reasoning path accompanying the answer based on the title block and the supporting fact block.

2. The method of claim 1, wherein the context representation is generated by inserting special fact tokens that signify starts of a sentence before each sentence of the respective passage.

3. The method of claim 1, wherein the decoded sequence contains a linearized sequence of alternating title blocks and supporting fact blocks, and
wherein the alternating title blocks and supporting fact blocks are selected from a sequence of passages indicating a reasoning for locating the answer to the multi-hop question from the collection of passages.

4. The method of claim 1, wherein the supporting fact block contains a fact starting token followed by a sequence of fact indicators corresponding to special fact tokens in the context representation.

5. The method of claim 1, wherein at least one input block from the plurality of input blocks contains a concatenation of the multi-hop question, a first title of a first passage, a first context representation of the first passage, a second title of a second passage, and a second context representation of the second passage.

6. The method of claim 1, wherein the decoded sequence is generated autoregressively per token at each step via a self-attention module, a cross-attention module and a feed-forward module.

7. The method of claim 1, wherein the decoded sequence is generated by the decoder in a form of a conditional probability distribution of the decoded sequence conditioned on the global input representation.

8. The method of claim 7, further comprising:
computing a loss objective based on an entropy of the conditional probability distribution of the decoded sequence conditioned on the global input representation; and
updating parameters of the encoder and the decoder by minimizing the loss objective.

9. The method of claim 1, wherein the answer is generated by parsing the decoded sequence based on an answer indicator.

10. The method of claim 9, wherein the reasoning path is generated by:
recursively parsing, the decoded sequence after removing the answer block, based on separator tokens indicating a start of the title block or the supporting fact block; and
reconstructing a title and relevant sentences at each hop of the recursive parsing.

11. A system for multi-hop question answering and reasoning via a natural language processing (NLP) model, the system comprising:
a communication interface receiving a multi-hop question and a collection of passages;
a memory for storing an encoder and a decoder, and a plurality of processor-executable instructions; and
a processor that executes the plurality of processor-executable instructions to perform operations comprising:
generating a plurality of input blocks, each of which contains a concatenation of the multi-hop question, a respective title of a respective passage, and a respective context representation of the respective passage;
encoding, via an encoder, the plurality of input blocks into a plurality of encoded input representations;
concatenating the plurality of encoded input representations into a global input representation;
generating, via a decoder in response to the global input representation, a decoded sequence containing a title block, a supporting fact block and an answer block; and
generating an answer to the multi-hop question based on the answer block and a reasoning path accompanying the answer based on the title block and the supporting fact block.

12. The system of claim 11, wherein the context representation is generated by inserting special fact tokens that signify starts of a sentence before each sentence of the respective passage.

13. The system of claim 11, wherein the decoded sequence contains a linearized sequence of alternating title blocks and supporting fact blocks, and
wherein the alternating title blocks and supporting fact blocks are selected from a sequence of passages indicating a reasoning for locating the answer to the multi-hop question from the collection of passages.

14. The system of claim 11, wherein the supporting fact block contains a fact starting token followed by a sequence of fact indicators corresponding to special fact tokens in the context representation.

15. The system of claim 11, wherein at least one input block from the plurality of input blocks contains a concatenation of the multi-hop question, a first title of a first passage, a first context representation of the first passage, a second title of a second passage, and a second context representation of the second passage.

16. The system of claim 11, wherein the decoded sequence is generated autoregressively per token at each step via a self-attention module, a cross-attention module and a feed-forward module.

17. The system of claim 11, wherein the decoded sequence is generated by the decoder in a form of a conditional probability distribution of the decoded sequence conditioned on the global input representation.

18. The system of claim 17, wherein the operations further comprise:
computing a loss objective based on an entropy of the conditional probability distribution of the decoded sequence conditioned on the global input representation; and
updating parameters of the encoder and the decoder by minimizing the loss objective.

19. The system of claim 11, wherein the answer is generated by parsing the decoded sequence based on an answer indicator.

20. A non-transitory processor-readable storage medium storing a plurality of processor-executable instructions for multi-hop question answering and reasoning via a natural language processing (NLP) model, the instructions being executed by a processor to perform operations comprising:
receiving, via a communication interface, a multi-hop question and a collection of passages;
generating a plurality of input blocks, each of which contains a concatenation of the multi-hop question, a respective title of a respective passage, and a respective context representation of the respective passage;
encoding, via an encoder, the plurality of input blocks into a plurality of encoded input representations;
concatenating the plurality of encoded input representations into a global input representation;
generating, via a decoder in response to the global input representation, a decoded sequence containing a title block, a supporting fact block and an answer block; and
generating an answer to the multi-hop question based on the answer block and a reasoning path accompanying the answer based on the title block and the supporting fact block.
